(19) United States
(12) Patent Application Publication
(10) Pub. No.: US 2004/0196868 A1
(43) Pub. Date: Oct. 7, 2004

(54) Method and system for prioritizing a telephone call

(76) Inventor: Neal J. King, Oakland, CA (US)

Correspondence Address: Bruce W. Slayden II, Baker Botts L.L.P., 910 Louisiana Street, Houston, TX, 77002-4995, US

(21) Appl. No.: 10/407,995

(22) Filed: Apr. 4, 2003

(51) Int. Cl. H04J 1/00

(52) U.S. Cl. 370/468

(57) ABSTRACT

An interface for coupling a telephone set with a digital network interface is disclosed wherein a bandwidth for each transmission over the digital network has to be allocated. The interface comprises a dialed-number detection unit for detecting a dialed number, a priority-assignment unit which determines a priority of a requested transmission based on the dialed number, and a bandwidth-allocation unit which allocates a bandwidth necessary to complete the requested transmission based on the determined priority.

### FIELD OF THE INVENTION

The present invention pertains generally to the field of telecommunication systems with the ability to allocate a specific bandwidth for each transmission.

### BACKGROUND OF THE INVENTION

In the field of telecommunications a plurality of systems exist. Generally, two types of system exist, first with a fixed number of transmission channels each having a fixed bandwidth, and a second type in which bandwidth is allocated dynamically for each transmission. In the latter, a demand to make a telephone call must compete with existing demands, such as currently performed transmissions or concurrent transmission demands. For example, a telephone call may demand bandwidth in form of an information-carrying capacity on a particular telecommunication link, such as an asymmetric digital subscriber line (ADSL) link. If the available bandwidth is insufficient, the telephone call cannot be made, until enough bandwidth will be available. Thus, other services have to be cancelled to provide the respective bandwidth or the system has to wait until one of the currently performed transmissions has terminated to free up enough bandwidth.

### SUMMARY OF THE INVENTION

Therefore, there is a need for an improved telecommunication system which dynamically allocates bandwidth for each transmission to improve performance of the system.

In accordance with a general aspect, inventions disclosed and described herein are directed, for example, to an interface for coupling a telephone set with a digital network interface wherein a bandwidth for each transmission over the digital network has to be allocated, comprising a dialed number detection unit for detecting a dialed number, a priority assignment unit which determines a priority of a requested transmission based on the dialed number, and a bandwidth allocation unit which allocates a bandwidth necessary to complete the requested transmission based on the determined priority.

The interface may further comprise a switch-hook detector for detecting an off-hook mode of the telephone set, and a dial-tone generator controlled by the switch-hook detector. The dialed-number detection unit may comprise a tone-detection unit coupled with a digit-recognition unit coupled with a number register. The dialed-number detection unit may comprise a pulse-counting/-detection unit coupled with a digit-recognition unit coupled with a number register. The interface may further comprise an override unit coupled with the priority-assignment unit and/or may comprise a relay controlled by a relay-control unit for coupling an analog telephone set with the digital network interface, wherein the relay-control unit is controlled by the priority-assignment unit. Furthermore, the interface can comprise a “Line Busy” message generator for generating an audio busy signal transmitted through the telephone set. The “Line Busy” message generator can be controlled by the bandwidth allocation unit. The priority-assignment unit can comprise a table in which phone numbers are stored and assigned to a respective priority level and a comparator unit for comparing the dialed number with the entries of the table. The table can be programmable. The priority-assignment unit may assign a priority to a phone number based on a predefined part of the phone number.

A method for initiating a telephone call over a digital network wherein a bandwidth for each transmission over the digital network has to be allocated, may comprise the steps of:

determining a dialed number;

assigning a priority to the dialed number; and

allocating a bandwidth based on the determined priority.

The step of allocating a bandwidth may comprise the step of terminating a current transmission with a lower priority if not enough bandwidth is available. The step of allocating a bandwidth may comprise the step of limiting the bandwidth of a current transmission with a lower priority if not enough bandwidth is available to provide enough bandwidth for the requested telephone call. The method may further comprise the step of detecting an off-hook mode of the telephone set, and generating a dial-tone for the user if an off-hook mode has been detected. The method may also further comprise step of providing an override mode for overriding an assigned priority of a requested telephone call. The method may also further comprise the step of generating a “Line Busy” message if not enough bandwidth can be allocated. The priority can be determined by comparing the determined telephone number with entries in a table in which phone numbers are stored and assigned to a respective priority level. The method may further comprise the step of providing a mode during which the entries in the table can be programmed. The priority can be determined by comparing a part of the determined telephone number with a predefined number to determine a respective predefined priority level. The priority can also be determined by comparing a part of the determined telephone number with a predefined range of numbers to determine a respective predefined priority level.

The present invention allows a system to operate in a way similar to conventional systems. Since it is expected that voice provided over a digital network (sometimes known as “voice over digital subscriber line” or VoDSL) will be used in a common-place environment, such as an office environment, it is dangerous to introduce a different protocol for emergency purposes that is used only for those phones using VoDSL. The present invention allows that those calls can be made in a familiar fashion with no difference to known analog systems. For example, no special buttons, such as a “SEND” button which might be necessary to complete a call, etc., are required by the present invention. Furthermore, the generation of a dial tone enhances the “compatibility” of the system to a user because it practically emulates a telephone system known to every person. Without some of the features of the present invention, a user would hear, for example, no dial tone until sufficient bandwidth has been allocated. Such a silence period might lead the user to believe that the telephone system is simply not functioning and force him to hang up. According to the present invention, a system can be designed which generates a dial tone within less than 50 ms in order to prevent the user from worrying about the availability of the telephone system. Other aspects and features of the inventions disclosed herein will become apparent hereinafter.

### BRIEF DESCRIPTION OF THE DRAWINGS

The drawings illustrate both the design and utility of preferred embodiments of the disclosed inventions, in which similar elements in different embodiments are referred to by the same reference numbers for ease in illustration, and wherein:

FIG. 1 shows an exemplary block diagram of a system using the principles of the present invention;

FIG. 2 shows a first embodiment of a telephone interface according to the present invention;

FIG. 3 shows a second embodiment of a telephone interface according to the present invention; and

FIG. 4 shows yet another embodiment of a telephone interface according to the present invention.

### DETAILED DESCRIPTION OF PREFERRED EMBODIMENTS

The present invention uses a prioritizing scheme to allocate the necessary bandwidth for a respective call. Thus, in case of high traffic on the network and no allocatable bandwidth, a call having a lower priority than current data/voice transmissions will have to wait until the necessary bandwidth is available. However, if the respective call has a higher priority, a data/voice transmission with a lower priority will be interrupted to free up enough bandwidth for the higher prioritized call. Usually, voice transmissions may have higher priorities than data transmissions to avoid any interruptions, however, this is not always necessary. A reduction in bandwidth of existing transmissions may also allow re-allocation of enough bandwidth to a more highly prioritized call without completely stalling current transmissions. In particular, voice transmissions over a digital network might generally have a higher bandwidth than necessary, thus, allowing some reduction to free up some bandwidth for other transmissions. According to the present invention, the number dialed for placing a telephone call will be used to determine the respective priority. To this end, a list may be defined or predetermined to set up priorities for specific numbers; for example, in the United States a call with the number “911” will have the highest priority.

Not all telephone calls should be given higher priority than other services provided over a digital line link, such as ADSL. It can be expected, however, that calls to an emergency number, such as “911” in the United States, should override the demands of any other service. The failure to provide the mechanism for making an emergency call could lead to a very sensitive legal and regulatory problem with a large degree of liability. It is therefore necessary to be able to set the priority of telephone calls on the basis of the dialed number as proposed by the present invention.

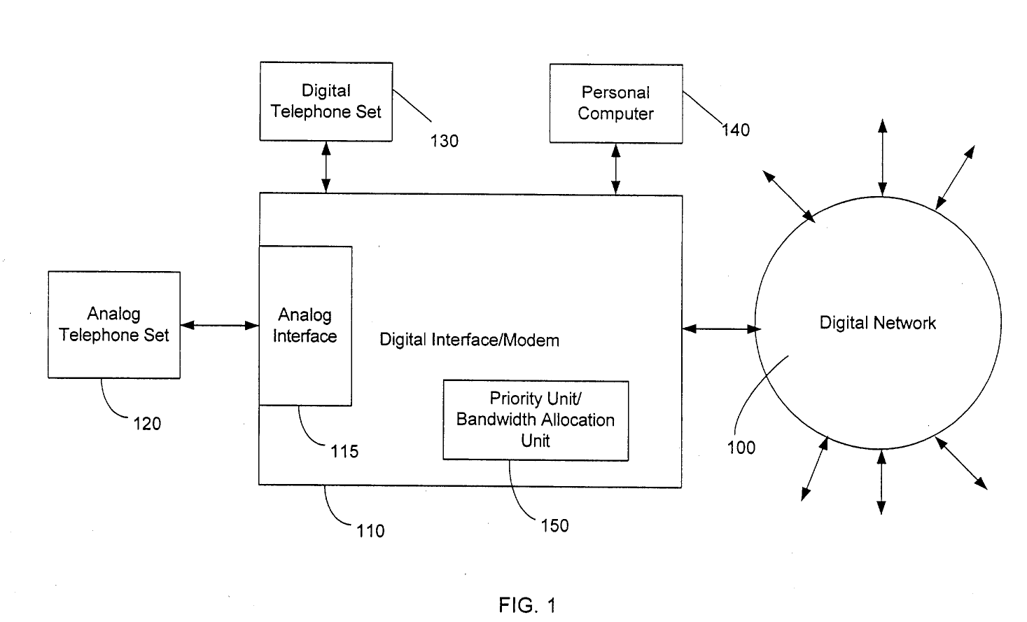

FIG. 1 shows a block diagram of an exemplary digital network including the ability of voice transmissions. The digital network 100 can be, for example, an ADSL digital subscriber line multiplexer (DSLAM) or any other appropriate digital link or network node. A user may couple different devices through a digital interface/modem 110. For example, a computer 140 can be coupled with the modem 110 through a respective digital connection. Furthermore, specifically designed digital telephone sets 130 may be coupled through a respective coupling of the digital interface/modem 110. However, the digital interface/modem may further comprise a specific analog interface 115 for coupling of existing standard analog telephone sets 120. Thus, a user does not have to purchase additional equipment and will be able to use older analog telephone sets with the new technology. The digital interface/modem 110 comprises further a priority unit 150 for prioritizing of respective transmissions and/or for determining the priority of telephone calls based on the dialed number.

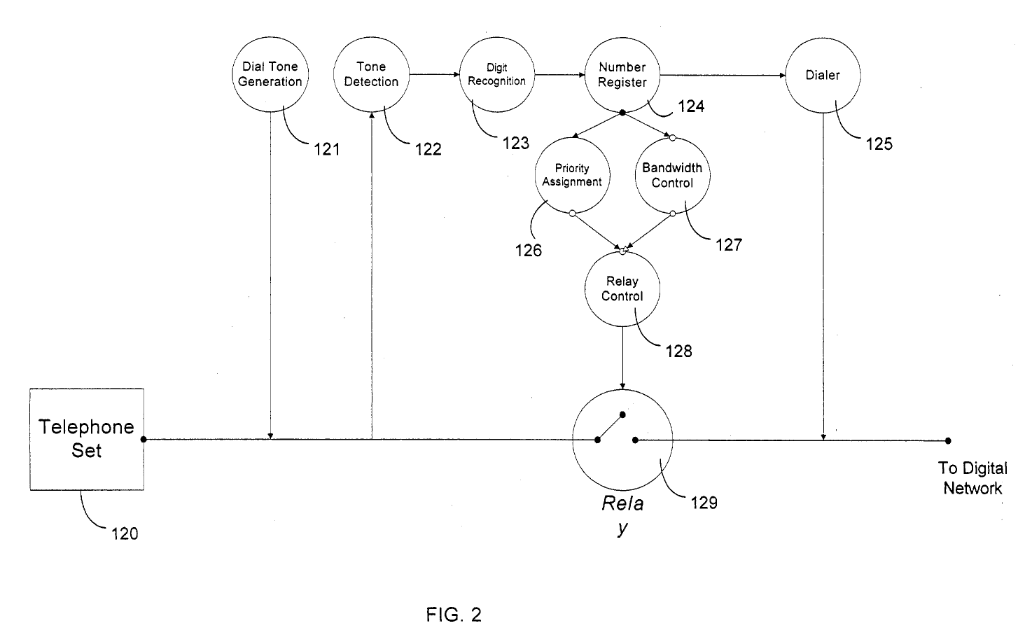

FIG. 2 shows a block diagram of a telephone interface in more detail. An analog telephone set 120 comprises a twisted-pair coupling which is coupled with a dial-tone-generation unit 121, a tone-detection unit 122, and a relay switch 129. The tone-detection unit 122 is coupled with a digit-recognition unit 123 which generates a digital representation of a dialed number which can be stored in a number register 124. The number register 124 is coupled with a priority-assignment unit 126 and a bandwidth-control unit 127. The priority-assignment unit 126 and the bandwidth-control unit 127 are further coupled with a relay-control unit 128 which controls the relay switch 129. The priority-assignment unit 126 and the bandwidth-control unit 127 may also control each other through respective control lines. The relay switch 129 is controlled to couple the analog telephone set coupling with the input of the digital interface/modem proper, for example, an analog-to-digital and digital-to-analog converter of the interface/modem. Furthermore, a dialer unit 125 can be provided which is coupled with the number register 124 and which is also directly coupled with the interface to the digital network to create the necessary dialing information.

Whenever the user dials a number, the tone-detection unit 122 and the digit-recognition unit 123 generate a digital representation of the dialed number which is then stored in number register 124. The priority-assignment unit compares this number with a list and generates a priority level. In parallel, the bandwidth-control unit 127 may determine a necessary bandwidth for the requested transmission. If the required bandwidth is available and no other co-pending transmission has a higher priority, a respective signal is sent to the relay-control unit 128 which couples the analog telephone set with the digital interface through the relay 129. The dialer unit 125 will also be instructed to generate the respective dialing command to initiate the requested call. If there is not enough bandwidth available, then priority-assignment unit 126 and bandwidth-control unit 127 determine whether there are transmissions pending which have lower priorities. If there are transmissions with a lower priority, then two scenarios can take place. In a first scenario, the bandwidth-control unit 127 may try to reduce the bandwidth of the lower priority transmissions until enough bandwidth is available to place the requested call, or in a second scenario, may terminate or stall one of the transmissions having a lower priority. If no lower-priority transmission is present, a respective message can be generated to indicate to the user that the system is currently not able to place the requested call until one of the currently running transmissions is terminated.

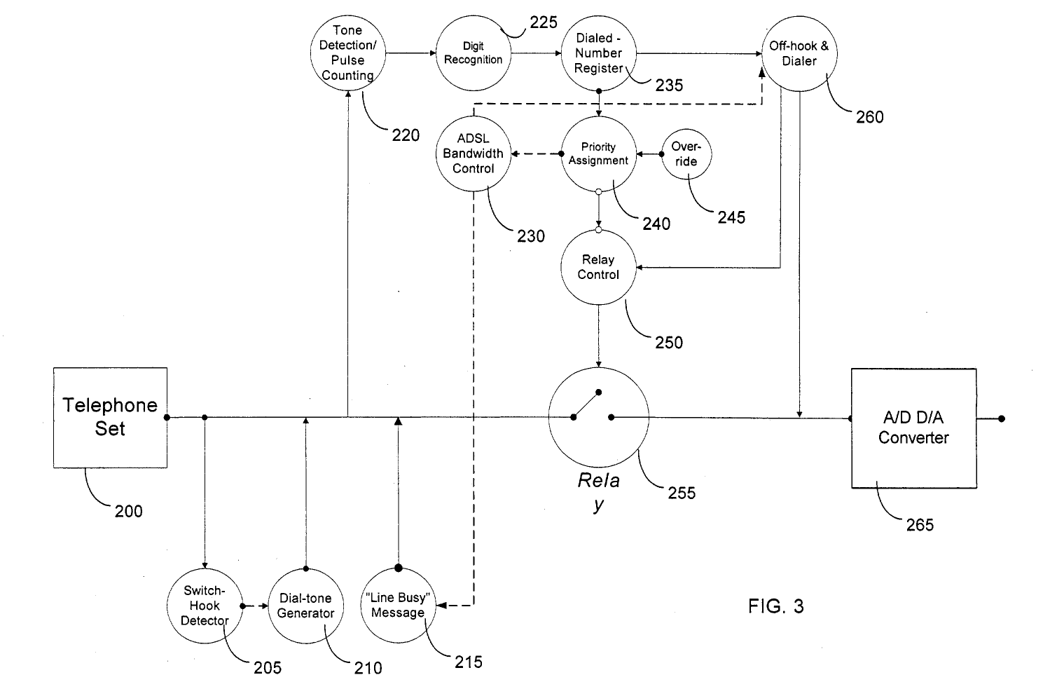

FIG. 3 shows another exemplary embodiment of a telephone interface in a block diagram. A standard analog telephone set 200 is coupled to the analog interface as shown in FIG. 1. The analog interface comprises a switch-hook detector 205 coupled to the analog telephone interface (usually a twisted pair connection). The switch-hook detector 205 controls a dial-tone generator 210 which is also coupled to the analog-telephone interface. A “line Busy” or “Resources not available” Message unit is provided which is also coupled with this analog telephone interface. Furthermore, the analog-telephone interface is coupled to a tone-detection/pulse-counting unit 220 which is coupled with a digit-recognition unit 225. The digit recognition unit 225 is coupled with a dialed-number register 235. This register 235 is also coupled with a priority-assignment unit 240 and a off-hook & dialer unit 260. The priority-assignment unit 240 receives further input by an override unit 245 and outputs signals for a ADSL bandwidth-control unit 230 and a relay-control unit 250. The relay-control unit 250 controls a relay 255 whose relay switch is coupled with the analog telephone interface and with the analog/digital digital/analog (A/D D/A) converter unit 265. The off-hook & dialer unit 260 is also coupled with this A/D D/A converter unit 265 and with the relay-control unit 250. FIG. 2 further indicates the control connection of the ADSL bandwidth-control unit 230 with the off-hook & dialer unit 260 and with the “line Busy” message unit 215. The A/D D/A converter unit 265 receives and sends all necessary digital signals to interface the analog telephone set 200 with the digital network.

During operation, relay 255 connects the telephone line of the telephone set 200 with the input of the ADSL interface/modem for transport over the ADSL link. If the telephone set 200 is not in use, the relay 255 is open whereby the telephone set 200 is disconnected from the switch. When a user picks up the telephone handset, the switch-hook detector unit 205 directs the dial-tone generator unit 210 which can be located in the VoDSL (voice over DSL) equipment in the customer's premises, to provide a dial tone to the telephone set 200. As the user begins to dial the number, the dial-tone generator unit 210 is stopped, as it would be if the dialing signals were being received directly by an analog telephone switch. Thus, the user will experience no difference to the former analog system he is used to operating. The dialing signals can be either dialing pulses or dual-tone multi-frequency (DTMF) tones. These dialed digits will be identified by the tone-detection/pulse-counting unit 220, converted into a digital number by the digit-recognition unit 225 and stored in the dialed-number register 235.

When the user has finished dialing, the priority-assignment unit 240 compares the number in the dialed number register 235 against its list of high-priority numbers, such as a “911” emergency call number. Alternatively, the priority-assignment unit 240 may examine the register 235 immediately after the third digit has been received and compare this number with the “911” emergency number for the United States, or respective equivalent numbers in other countries.

In either approach, if the priority assignment unit 240 has determined that this call is a high-priority call, it commands the bandwidth-control unit 230 to signal to the ADSL modem to allocate the bandwidth to connect the telephone set to the telephone switch, for example, through the A/D D/A converter unit 265. If necessary, some of the services/transmissions are dropped or bandwidth-limited by the ADSL link in a peremptory fashion as described above.

If the priority-assignment unit has not determined that this call has a high priority, it commands the ADSL bandwidth control unit 230 to signal to the ADSL modem to allocate the bandwidth to connect the telephone set to the telephone switch conditional on bandwidth being available. If the bandwidth is not available, the ADSL bandwidth control unit 230 signals to the “line Busy” message unit 215 to generate an audible signal indicating to the user that the ADSL line is busy. This could be, for example, a special set of tones, or a voice message stating “The ADSL link is busy, please turn off some of the services you are using.” The user can then hang up, turn off some of the services/transmissions, and try to use the telephone again.

If the ADSL modem is allowed to allocate bandwidth to the telephone connection, the modem will set up the connection so that information sent from the telephone-switch side of the relay 255 will be received by the telephone set 200 and vice versa. The ADSL modem informs the ADSL bandwidth-control unit 230 of this state. The ADSL bandwidth-control unit directs the Off-hook & dialer unit 260 to generate signals indicating that the telephone set 200 has gone off hook, such as grounding the tip and ring lines of the telephone cable, and then, after an appropriate delay, transmit the number in the dialed number register 235 over this connection. It may transmit this number using DTMF tones, dialing pulses, or any other appropriate form of telephone-to-switch signaling.

Immediately after transmitting the dialed number, the Off-hook & dialer unit 260 commands the relay control unit 250 to close the relay 255, thereby truly connecting the telephone set 200 to the telephone switch for the first time in this interaction.

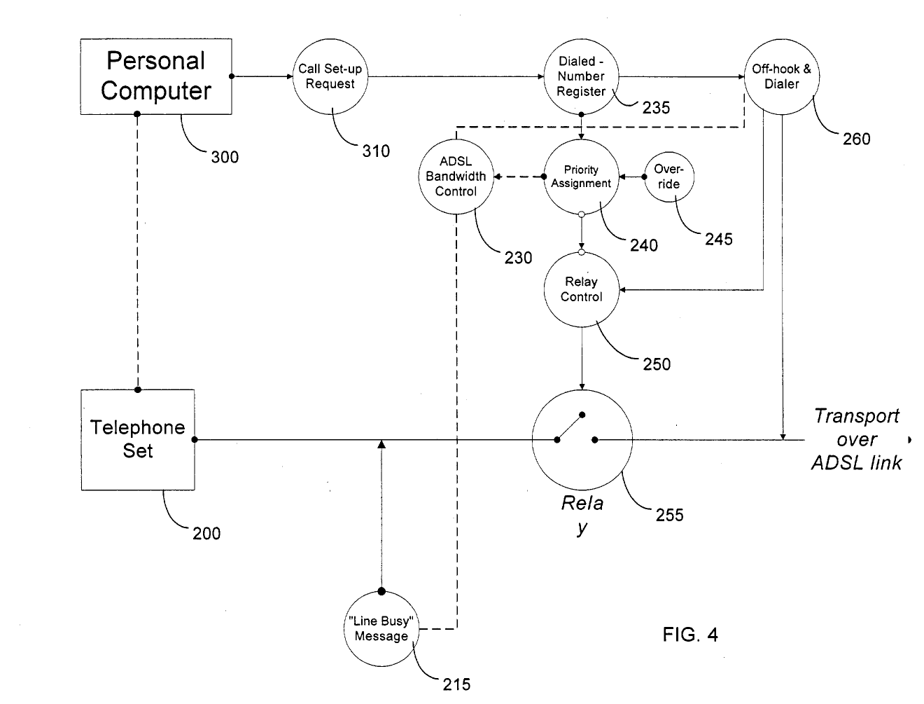

FIG. 4 shows yet another exemplary embodiment of the present invention. Similar elements carry the same numerals in this figure. In addition, a personal computer 300 controls some of the functions of the analog telephone set 200. To this end the personal computer 300 may be coupled with the telephone set 200, for example, through a serial interface. The personal computer 300 is coupled with a call set-up request unit 310 which directly feeds a telephone number to the dialed number register 235.

In this embodiment, a user selects a telephone number, for example, from a data base of a specific computer application such as a dedicated telephone-dialer program. The computer 300 transmits this number either through the telephone set and, thus, initiates the same procedure as described with respect to FIG. 3, or directly transmits the number into the dialed number register 235 through the call set-up request unit. In either case, similar steps follow to set up a connection as described with respect to FIG. 3.

The above exemplary embodiments assume that the connection between the relay 129, 255 and the ADSL transport is a traditional analog tip/ring line as used with respect to analog telephone sets and discusses the actions of the Off-hook & Dialer unit 125, 260 in terms of the normal signaling between telephone and telephone switch. In practice, this part of the connection can of course also be realized with a digital connection using a digital telephone set. In such a scenario, there will be no connection in an analog form, thus, there may not be a physical off-hook and dialed DTMF tones or pulses. For example, if the telephone switch is configured to accept in-band a/b-signaling, the off-hook & dialer unit can transmit a/b-bits to indicate going off-hook; or if the telephone switch can be configured to accept integrated service digital network (ISDN) signaling (e.g. Q.931), the Off-hook & Dialer module can transmit a call set-up request including the dialed number.

In some telephone systems, the telephone handset need not be taken off-hook to initiate a telephone call; for example, if a telephone comprises a speaker-phone mode for which a button is pressed to put the telephone set into an off-hook state. In another system, a telephone number is typed on the keyboard of a personal computer and a specific command key has to be pressed to initiate a call. In yet another scenario a dedicated voice command has to be analyzed and detected by a respective voice recognition software to initiate a call. The above described systems can be respectively adapted to accommodate the respective telephone system. As described with respect to FIG. 4, for example, a number can be directly transferred to a dialed number register, and in fully digital systems the relay can be replaced by a respective digital link. Some of the units may then no longer be needed because the user interface of the telephone system does not give the user any expectations, for example, of a dial tone.

In addition, as shown in FIGS. 3 and 4, an override unit 245 can be provided. Such a unit allows the user to set the priority of the particular telephone call to “high”, regardless of the number dialed. Such a mode could be initiated, for example, by pressing a button just before, after, or during the dialing of the number.

Furthermore, the priority assignment unit 240 could be programmable, either by the user or by an administrative system, to edit the list of dialed numbers to be given high priority, or to enforce a policy such as giving all dialed numbers a high priority or even giving no dialed number a high priority. For example, a specific sequence of numbers can initiate a priority setup mode. To this end, a user dials, for example, “*5” followed by a respective telephone number, the system can then reply through a voice command or a message on a telephone set display requiring the user to enter a priority level. The priority level can be a selected one, for example, from the group of “High=1, Medium=2, Low=3, None=4” or a predetermined number from a priority level 0-9, with 0 being the lowest and 9 the highest priority. The assignment unit can further include an evaluation unit which assigns a priority level based on a partial number, such as an area code, or a specific part of a phone number (for example the first four digits). Furthermore, a range of such partial numbers can be associated with a specific priority level. For example, all numbers within the range of 202 5xx xxxx-202 7xx xxxx will be assigned to priority “High”. Furthermore, depending on the display capabilities of the phone, an edit mode could be provided which allows one to edit, add, or delete phone numbers and their respective priorities. Such a feature would be in particular feasible within a computer system coupled with the telephone set or the digital interface/modem.

The method and embodiments above are described for telephone sets provided with connection to a telephone switch using ADSL. However, these methods/embodiments can also be applied to any other type of digital transport system, such as the family of systems known as xDSL, or any communication system in which the availability of some resource must be negotiated before completing a call.

Although particular embodiments of the invention have been shown and described, the invention is not limited to the preferred embodiments and it will be apparent to those skilled in the art that various changes and modifications may be made without departing from the scope of the invention, which is defined only by the appended claims and their equivalents.

What is claimed:

1. Interface for coupling a telephone set with a digital network interface wherein a bandwidth for each transmission over the digital network has to be allocated, comprising:
a dialed number detection unit for detecting a dialed number;
a priority assignment unit which determines a priority of a requested transmission based on the dialed number; and
a bandwidth allocation unit which allocates a bandwidth necessary to complete the requested transmission based on the determined priority.

2. Interface as in claim 1, further comprising a switch-hook detector for detecting an off-hook mode of the telephone set, and a dial-tone generator controlled by the switch-hook detector.

3. Interface as in claim 1, wherein the dialed-number detection unit comprises a tone-detection unit coupled with a digit-recognition unit coupled with a number register.

4. Interface as in claim 1, wherein the dialed-number detection unit comprises a pulse-counting/-detection unit coupled with a digit-recognition unit coupled with a number register.

5. Interface as in claim 1, further comprising an override unit coupled with the priority-assignment unit.

6. Interface as in claim 1, further comprising a relay controlled by a relay-control unit for coupling an analog telephone set with the digital network interface, wherein the relay-control unit is controlled by the priority-assignment unit.

7. Interface as in claim 1, further comprising a “Line Busy” message generator for generating an audio busy signal transmitted through the telephone set.

8. Interface as in claim 7, wherein the “Line Busy” message generator is controlled by the bandwidth allocation unit.

9. Interface as in claim 1, wherein the priority-assignment unit comprises a table in which phone numbers are stored and assigned to a respective priority level and a comparator unit for comparing the dialed number with the entries of the table.

10. Interface as in claim 9, wherein the table is programmable.

11. Interface as in claim 1, wherein the priority-assignment unit assigns a priority to a phone number based on a predefined part of the phone number.

12. Method for initiating a telephone call over a digital network wherein a bandwidth for each transmission over the digital network has to be allocated, comprising the steps of:
determining a dialed number;
assigning a priority to the dialed number; and
allocating a bandwidth based on the determined priority.

13. Method as in claim 12, wherein the step of allocating a bandwidth comprises the step of terminating a current transmission with a lower priority if not enough bandwidth is available.

14. Method as in claim 12, wherein the step of allocating a bandwidth comprises the step of limiting the bandwidth of a current transmission with a lower priority if not enough bandwidth is available to provide enough bandwidth for the requested telephone call.

15. Method as in claim 12, further comprising the step of detecting an off-hook mode of the telephone set, and generating a dial-tone for the user if an off-hook mode has been detected.

16. Method as in claim 12, further comprising step of providing an override mode for overriding an assigned priority of a requested telephone call.

17. Method as in claim 12, further comprising the step of generating a “Line Busy” message if not enough bandwidth can be allocated.

18. Method as in claim 12, wherein the priority is determined by comparing the determined telephone number with entries in a table in which phone numbers are stored and assigned to a respective priority level.

19. Method as in claim 18, further comprising the step of providing a mode during which the entries in the table can be programmed.

20. Method as in claim 12, wherein the priority is determined by comparing a part of the determined telephone number with a predefined number to determine a respective predefined priority level.

21. Method as in claim 12, wherein the priority is determined by comparing a part of the determined telephone number with a predefined range of numbers to determine a respective predefined priority level.
